(19) United States
(12) Patent Application Publication
(10) Pub. No.: US 2026/0348117 A1
(43) Pub. Date: Nov. 5, 2026

(54) CONTAINMENT BOOMS

(71) Applicant: GB Ocean AS, MANDAL (NO)

(72) Inventor: Per Martin HELLAND, Mandal (NO)

(73) Assignee: GB Ocean AS, MANDAL (NO)

(21) Appl. No.: 19/125,375

(22) PCT Filed: Oct. 31, 2023
(86) PCT No.: PCT/NO2023/060079

§ 371 Date: Apr. 29, 2025

(30) Foreign Application Priority Data
Oct. 31, 2022 (NO) 20221165

(51) Int. Cl. E02B 15/06; B63B 35/32; E02B 15/04; E02B 15/08

(52) U.S. Cl. CPC E02B 15/06; B63B 35/32; E02B 15/047; E02B 15/0828; E02B 15/0835; E02B 15/085

(57) ABSTRACT

A containment boom is for confining a spill in a region of water, the containment boom being configured to be supported on water. The containment boom has: a containment body; and a link means for movably connecting and linking the containment body to a variable water level structure, permitting lift/lower movability of the containment body on the water in use with respect to the variable water level structure with relative changes in water level; wherein the link means is attached to the containment body through a reconfigurable attaching structure in which one part is releasable or separable or configured to break apart from another part by an applied force in use. Also described is a related system, vessel and method of use.

### CROSS-REFERENCE TO RELATED APPLICATIONS

This application is the U.S. national stage application of International Application No. PCT/NO2023/060079, filed Oct. 31, 2023, which international application was published on May 10, 2024, as WO 2024/096745 in the English language. The International Application claims priority to Norwegian Patent Application No. 20221165, filed Oct. 31, 2022. The international application and Norwegian application are both incorporated herein by reference, in their entirety.

### FIELD

The present invention relates to spills in water, and in particular, it relates to a containment boom for confining a spill in a region of water, a related system, and a vessel with a containment boom connected thereto.

### BACKGROUND

Spills of substances such as chemicals, oil, or contaminants into water can be undesirable and/or harmful to the environment. Containment booms are known for containing oil spills within a defined containment region at the surface of the water. They can be deployed in the water to surround a region of water and keep an oil spill within the surrounded region.

The published PCT patent application WO2021/158119 describes a containment boom. Ends of the containment boom are connected to one another by an openable link, which may be a magnetic weak link.

Operations taking place at shoreside or offshore terminals, harbours, quaysides or the like have the potential for harmful spills into water. Spills can occur for example when offloading cargo from a ship moored at a quay.

### SUMMARY

An aim of the present invention is to provide improved means of containing spills in water, for various operational contexts. Amongst various aims and objects of the invention more generally is to obviate or at least mitigate one or more drawbacks of prior art.

According to a first aspect of the invention, there is provided a containment boom for confining a spill in a region of water, the containment boom being configured to be supported on water, the containment boom comprising: a containment body; and a link means for movably connecting and linking the containment body to a variable water level structure, permitting lift/lower movability of the containment body on the water in use with respect to the variable water level structure with relative changes in water level; wherein the link means is attached to the containment body through a reconfigurable attaching structure in which one part is releasable or separable or configured to break apart from another part by an applied force in use. The link means may for example comprise one or more magnet rollers to travel up/down on the variable water structure with changes in water level, in use. The one or more magnet rollers may be configured to be detachable from the variable water level structure upon a pulling the link means away from the variable water level structure with a force exceeding a threshold value

The one part can be a part of the link means and the other part can be any of: another part of the link means; a part of the containment body; a part of the attaching structure.

The link means can comprise one or more rollers, e.g. one or more magnet rollers each being magnetic or magnetically engageable or attachable to link the containment body to the variable water level structure, the rollers being rollable on up or down on the variable water level structure, when linked, in use.

The reconfigurable attaching structure can comprise: one or more first eyelets, loops, or holes; one or more second eyelets, loops, or holes; and at least one coupling member which is arranged to couple the first eyelets, loops, or holes and the second eyelets, loops, or holes.

The reconfigurable attaching structure can comprise an assembly for attaching the one or more rollers, typically one or more magnet rollers, to the containment body.

More specifically, the assembly can comprise axles upon which the rollers respectively can be rotatably mounted. Each axle can be supportably connected to a support member. The assembly can further comprise one or more fixtures of or affixed to a section of fabric or material of the containment body. The fixtures can be or comprise one or more first connector devices. The assembly can further comprise second connector devices which may be affixed to the support members. The assembly can further comprise at least one coupling member linking the first connector devices and the second connector devices. The first and second connector devices may be so linked as to couple the support members for the axles to the fixtures. The first connector devices can be eyelets, loops, or holes. The second connector devices can be eyelets, loops, or holes. The coupling member can be an elongate member. The coupling member can be arranged to pass through or engage the eyelets, loops, or holes.

The reconfigurable attaching structure extending between the link means and the containment body can comprise at least one severable link or weak link. Any of the parts comprising the following may be or may be configured to include at least one severable or weak link: any one or more eyelets, loops, or holes, or any part to which they are affixed or integral with; any one or more fixtures affixed to the containment body; any coupling member; any support member, e.g. support member for the roller or rollers; any axle, pin or bolt for rotatably supporting thereupon the roller or rollers. The severable or weak link may thus give way or sever upon application of the force exceeding a threshold value, the force for example urging the one part away from another or breaking a connection, so that at least one part can be released, or separated, or break apart, from at least one other. The threshold value that is less than the tear or breaking limit of the material or fabric of the containment body to which the link means is attached.

The containment body may typically be configured to float on the water The containment body can comprise a beam section or float section and a skirt arranged to depend from the beam section or float section into the water. The skirt may typically comprise impermeable material or fabric.

The containment body have a section of water permeable material configured to extend laterally underwater, for example from a lower portion of the skirt when linked to the variable water structure in use.

The link means may comprise a member that is movable up or down with respect to the variable water level structure when coupled to the structure in accordance with changes in water level with respect to the structure.

The link means may in general comprise at least one roller for rolling up or down the variable water level structure when movably linked to the structure. The roller can be cylindrical. Alternatively, the roller can be spherical.

The link means may be configured to magnetically link the containment boom to the variable water level structure. More specifically, the link means may comprise at least one magnet for magnetically linking the containment boom to the structure. The roller may be magnet for magnetically linking the containment boom to the structure.

The link means may comprise a block of material for magnetically linking the containment boom to the structure. The material may comprise at least one magnet or magnetic particles. The material may comprise magnetic compound for magnetically linking the containment boom to the structure.

The containment boom can be substantially as described anywhere herein.

According to a second aspect of the invention, there is provided a system comprising at least one variable water level structure and the containment boom in accordance with the first aspect of the invention, wherein the containment body is supported floatingly on the water and is connected and linked to the variable water level structure through the link means, the linked containment body and the link means being movable by the water to lift/lower with respect to the variable water level structure with relative changes in water level.

The link means can typically be magnet rollers arranged to travel up/down on the variable water structure with changes in water level, the magnet rollers being configured to be detachable from the variable water level structure upon a pulling the link means away from the variable water level structure with a force exceeding a threshold value.

According to a third aspect of the invention, there is provided a vessel, for example a fishing vessel, having a containment boom extending between first link means at one end of the boom and second link means at a second end of the boom the first and second link means movably connecting and linking the containment boom to a side of the vessel so as to rise/lower with respect to the side of the vessel with changes in water line, a region of water being confined by the boom between the boom and the vessel, the containment boom having a containment body and a section of permeable material extending laterally below the confined body of water, for collecting waste, for example fish processing waste, being discharged from the vessel into the region of water. Either or both the first and second link means may for example comprise one or more magnet rollers arranged to travel up/down on the variable water structure with changes in water level. The one or more magnet rollers may be configured to be detachable from the variable water level structure upon a pulling the link means away from the variable water level structure with a force exceeding a threshold value.

According to a fourth aspect of the invention, there is provided a method of using the containment boom of the first aspect of the invention, the containment boom being deployed in the water and the containment body being connected and linked to a variable water line structure, the method comprising the step of subjecting the reconfigurable structure, through which the link means is attached to the containment body of the containment boom, to such force as to release, separate or brake away at least one part from at least one other part to reconfigure the containment boom.

The part can preferably be released, separated or broken away from the other part by an applied force exceeding a threshold value that is less than the tear or breaking limit of the material or fabric of the containment body to which the link means is attached.

The one part may be a stuck or obstructed part, and the method may thus further comprise mechanically pulling part of the attaching structure, the containment body, or the attaching structure to apply the force to release, separate, or break away the one part from the other.

The method may include reconfiguring the containment boom in order to unstick, decouple or release one part of the boom from another in order to facilitate further operation or retrieval of the boom.

The method may include reconfiguring the containment boom in order to permit or facilitate retrieval or removal of any of the attaching structure, the containment body and link means from the water and/or variable water level structure.

According to a fifth aspect of the invention, there is provided a vessel or variable water level structure with the containment boom in accordance with the first aspect of the invention movably linked to the vessel or the variable water level structure.

According to further aspect of the invention, there is provided a containment boom for confining a spill in a region of water, the containment boom comprising: a body to be supported on water; and at least one end portion of the body comprising link means for obtaining an openable movement link having lift/lower movability of the body with respect to a variable water level structure with relative changes in water level. The body may be a containment body.

According to a yet further aspect of the invention, there is provided a system comprising at least one coupling which comprises an openable movement link between an end portion of the body of the containment boom according to the further aspect and a variable water level structure. Typically, the openable movement link is a weak link which is severable upon applying a pulling force exceeding a threshold value to decouple the containment boom from the structure. The weak link may be a magnetic weak link. The pulling force may then be applied to be sufficient to overcome a magnetic force that attracts the link means to attach to a part of the structure. Advantageously, the openable movement link can permit movement of the containment boom upward/downward with respect to the structure. Typically, the openable movement link includes or comprises the link means of the containment boom. More typically, the link means, e.g. a link member, of the openable movement link is movable upward/downward with respect to the variable water level structure. The variable water level structure may be quay or a vessel.

Any of the aspects of the invention may further include any feature of any other aspect of the invention wherever described herein.

Embodiments of the invention may be advantageous in various ways as apparent from throughout herein.

### BRIEF DESCRIPTION OF THE DRAWINGS

There will now be described, by way of example only, embodiments of the invention, with reference to the accompanying drawings, in which:

FIG. 1 is a side representation of a containment boom, in use, between two variable water level structures, one being a quay the other being a vessel;

FIG. 2 is an overhead representation of the containment boom of FIG. 1, in use and in smaller scale;

FIG. 3 is a side perspective representation of part of the containment boom of FIGS. 1 and 2, showing the link means, in larger scale;

FIG. 4 is a side perspective representation showing the link means of the containment boom of FIGS. 1 and 2, according to another example, in larger scale;

FIG. 5 is a side perspective representation showing the link means of the containment boom of FIGS. 1 and 2, according to yet another example, in larger scale;

FIG. 6 is an overhead representation of containment booms in use between two variable water level structures, both being vessels, in smaller scale;

FIG. 7 is an overhead representation of a containment boom in use, respective ends coupled to one variable water level structure, in the form of a vessel;

FIG. 8 is a perspective representation of another containment boom;

FIG. 9 is a perspective representation of another containment boom;

FIG. 10 is a side representation of the containment boom of FIG. 8 or 9 in use on a fishing vessel;

FIG. 11 is a perspective representation of a containment boom according to another example showing in particular the configuration of the link means at one of the ends;

FIG. 12 is a perspective representation of detail of the link means of the containment boom of FIG. 11;

FIG. 13 is a perspective representation of a fastener for connecting the main body to the link means of the containment boom of FIG. 11, in larger scale;

FIG. 14 is an end-on representation of the fastener of FIG. 13;

FIGS. 15A and 15B are perspective and end-on schematic representations respectively of the one end of the containment boom of FIG. 11 according to an example;

FIGS. 16A and 16B are perspective and end-on schematic representations respectively of the one end of the containment boom of FIG. 11 according to another example; and

FIGS. 17A and 17B are perspective and end-on schematic representations respectively of the one end of the containment boom of FIG. 11 according to yet another example.

### DETAILED DESCRIPTION OF THE DRAWINGS

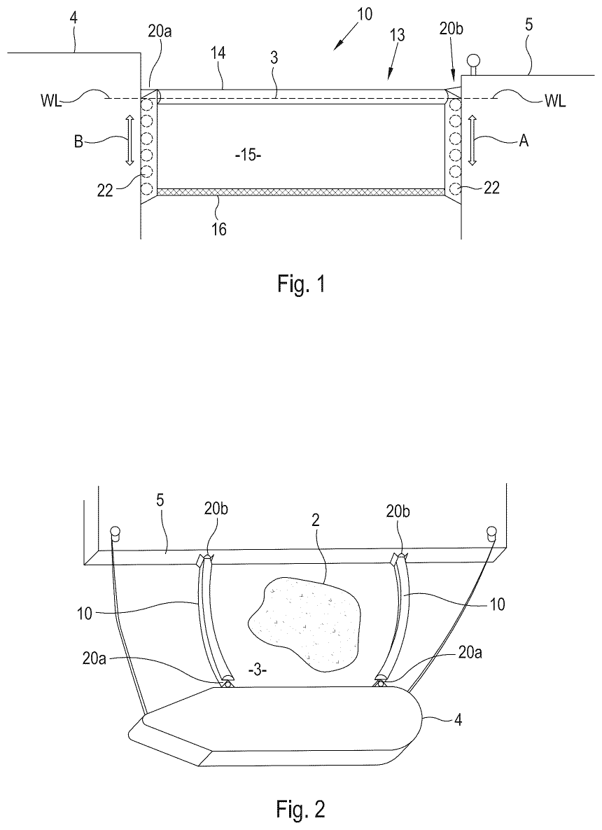

In FIGS. 1 to 3, containment booms 10 extend between a side of a vessel 4 and a quayside structure 5. The containment booms 10 are laterally spaced apart. A region of water 3 is defined between the containment booms 10 for confining an oil spill 2 in the region of water 3.

One end of each containment boom 10 is connected to the side of the hull of the vessel 4, and the other end of each containment boom 10 is connected to the side wall of the quayside structure 5. The containment boom has a main body extending longitudinally between the ends that floats on the surface of the water.

Each containment boom 10 is provided with link means 20a for coupling the containment boom 10 to the side of the vessel 4 and link means 20b for coupling the containment boom 10 to the quayside structure 5. The link means 20a forms a first openable movement link between the one end of the containment boom 10 to the vessel and the link means 20b forms a second openable movement link between the other end of the containment boom 10 and the quayside structure 5. By way of the link means 20a, 20b, the containment boom 10 is movable to lift or lower in the water relative to the vessel 4 as indicated by arrows A and/or relative to the quayside structure 5 as indicated by arrows B in dependence upon the water level WL relative to the vessel and/or the quayside structure 5. The containment boom 10 can then move with the water relative to the vessel and/or quayside structure.

Conveniently, the containment boom 10 can be used to span a region of water between pre-existing structures where there may be a requirement for a containment boom. The containment boom 10 can together with the structure to which it is coupled confine an oil spill to the region of water. That is, the structure and the containment boom 10 can both act as barriers to contain a surface spill laterally within a certain area of the water, e.g. sea. The containment boom may be provided to span short distances, and relatively short barriers can in such circumstances be sufficient for purpose of containing a spill. The movement link allows the containment boom to maintain an operational position and act effectively when water levels change. Water level changes may occur for example due to tidal variations. Also, the water level relative to a floating vessel, such as a cargo ship or the like, may change as cargo is offloaded from or loaded onto the ship. The containment boom 10 can be particular useful therefore e.g. in harbour or cargo terminal settings for use in order to confine an area of water during cargo loading or offloading where spills may occur, e.g. in the offloading of chemicals or oil or the like.

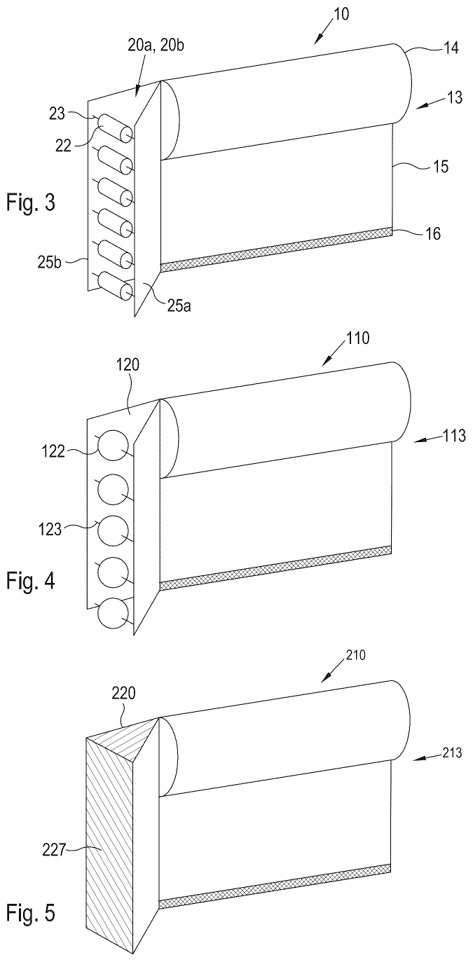

The link means 20a in FIG. 3 includes rollers 22 which are rollable upward/downward when attached to the hull of the vessel 4. The rollers are rollable on a side surface of the hull. In this example, the rollers 22 comprise magnets so that the rollers 22 also attach magnetically to the hull. The magnets produce a magnetic force for magnetic attachment of the link means to the side surface of the hull. An openable movement link is thus obtained, which in this example is a weak link that can be opened by detaching the end of the containment boom from the vessel by pulling the end of the containment boom away from the side of the hull with sufficient force. When attached, the rollers are in contact with a surface of the side of the vessel. The rollers 22 are configured to roll about horizontal axes, in this example on horizontal axles 23, allowing the end of the containment boom 10 to travel upward or downward with respect to the vessel in response to the relative changes in the level of the water and up/down movement of the body of the containment boom floating in the water. The magnets are configured to provide suitable magnetic force for attachment to the hull yet still allow movement upward in response to the buoyant force exerted by the water upon the containment boom 10 upon changing water levels.

The body 13, i.e. a “containment body”, of the containment boom 10 extends between the respective ends of the containment boom 10. The body 13 is configured to be buoyant to float upon the surface of the water for containing an oil spill at the surface of a region of water. The body 13 has a float section 14 configured to self-position at or near the surface of the water, and a skirt 15 depending from the float section so as to extend downward from the float section into the water in use. Along the lower rim of the skirt 15, the skirt 15 also has sinking structure, in this case a chain section 16, for weighting the skirt 15 in the water against the buoyant force of the float section. The skirt is 15 has a material that facilitates to contain the spill material within the region of water confined by the containment boom 10. Typically therefore, the material of the skirt is an impermeable sheet material, e.g. membrane, that is at least impermeable to oil or pollutant and/or the water. In this way, the skirt can help to hinder penetration of spill substances laterally past the containment boom 13.

At the end of the boom 10, the body 13 has a structure comprising support limbs 25a, 25b for mounting the rollers 22 on pivots 23 to the boom 10. The rollers 22 are arranged in the vertical channel between limbs 25a, 25b.

In FIG. 4, the containment boom 110 in one variant has an end portion with link means 120. The link means 120 comprises spherical rollers 122 as opposed to the cylindrical rollers 22 of the containment boom 10 described above. The spherical rollers are mounted on pivots 123 to a structure at the end of boom 110 and comprise magnets to attach magnetically and movably with respect to a structure such as the vessel or quayside structure. The spherical rollers can be configured to have higher magnetic attraction with less rolling friction compared with for example the cylindrical variant, and may therefore facilitate ease of movement of the boom upward or downward in the water.

In FIG. 5, the containment boom 210 in one variant has an end portion with link means 220. The link means 220 comprises magnetic compound 227 configured to attach to the structure, e.g. the surface of the vessel or the quayside structure. The magnetic compound 227 in this example is magnetic rubber. A block of the magnetic compound 227 is arranged at the end of the body 213 of the containment boom 210. The amount of magnetic particles within the compound is selected to provide the necessary magnetic force for attachment to a surface of the structure, yet the block of the compound upon contact against the surface is smooth and/or adapted to have sufficiently low friction to move and allow the end of the body to move up/down with respect to the structure in response to the variation in sea level.

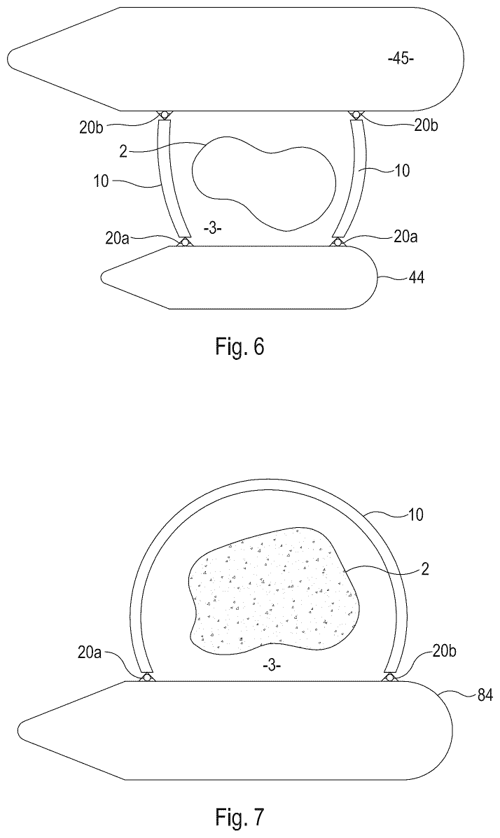

In certain examples, the containment boom(s) 10 can be used in different ways. In FIG. 6, two containment booms 10 are used like in FIG. 2 except that they span between different structures, namely a first vessel 44 and a second vessel 45. The booms 10 confine a spill 2 at a surface of the water to a region of water between the two vessels 44, 45 and between the booms 10. In FIG. 7, one containment boom 10 is used with both the first and second ends of the containment boom coupled to one structure, namely the vessel 84, via link means 20a, 20b. The containment boom 10 extends in a loop between the first and second ends defining an area of water within the loop between the containment boom and the vessel.

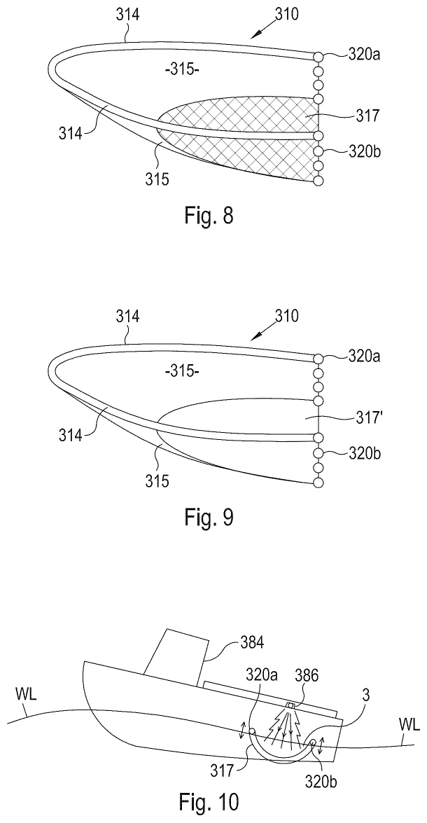

In FIG. 8 an alternative containment boom 310 is depicted. The containment boom comprises a main body extending between respective ends of the boom. The ends of the boom 310 have link means 320a, 320b for coupling to the side of a structure or vessel and moving up and down with the water line. In this example, containment boom 310 forms a bowl or bag structure under the water between the ends. In this regard, the containment boom 310 includes a section 317 of material that extends laterally from the lower part of the skirt 315 and provides a permeable base of the bowl or bag structure. In FIG. 8, the section of material 317 comprises a tightly woven mesh or netting. In FIG. 9, the material 317′ is a permeable fabric. The section of material 317, 317′ allows water to pass through the material, whilst oil, contaminants, chemicals or the like may not pass, and can therefore be collected and confined within the back area above the section of material in the region of water 3 enclosed by the containment boom 310.

FIG. 10 shows the containment boom 310 applied to the side of a vessel 384. The ends are both coupled through link means 320a, 320b to the side of the vessel for movement up/down with the waterline WL for appropriately positioning the containment boom 310 with the float element at the surface. The section of material 317 extends under the water surface. Material is discharged from an outlet 386 is discharged into the region of sea 3 within the boom. Contaminants, chemicals, foam, sea pollutants are prevented from passing through the material, and can be contained and collected from the region of sea 3.

In certain examples, the vessel 384 is a fishing vessel. Fish processing on the fishing vessel typically generates foam and other waste products. The foam and waste products from fish processing can in such an example be discharged into the confined region of water 3, e.g. through an outlet 386, contained by the containment boom 310 in the water, and then removed to land upon lifting the containment boom 310 from the water after use. Normally such foam and waste products from fish processing are discharged from the fishing vessel straight to sea causing undesired pollution, without any other handling of this waste. The same could be done with the containment boom 310 applied to the side of other structures, such as quayside structure.

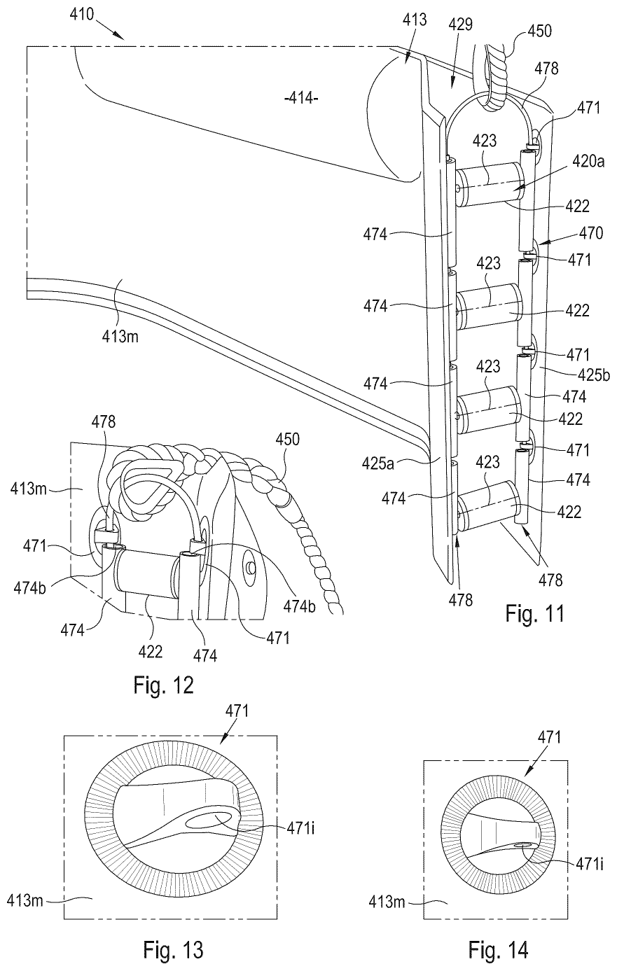

Turning now to refer particularly to FIG. 11, link means 420a of containment boom 410 is depicted. The link means 420a is arranged at the one end of the containment boom. The other end of the containment boom 410 can also be provided with a link means configured in the same way as the link means 420a. The link means 420a comprises a set of magnetic rollers 422 for movably coupling the containment boom 410 to a side of a structure. The rollers 422 may operate as those described above in relation to FIG. 3, for permitting movement of the containment boom 410 up or down in accordance with the water level acting upon the float element 414 of the containment boom. The magnetic rollers 422 in use magnetically attach to a side of a vessel and are rollable up and down with the water level while attached. The magnetic rollers 422 are vertically spaced apart and rotate about horizontal axes.

The containment boom 410 includes an attaching structure through which the link means 420a is attached to the containment body 413 that extends between the ends of the boom. The attaching structure in this example is in the form of attachment assembly 470 for attaching the magnetic rollers 422 to the containment body 413 of the boom 410, which is described now in further detail with additional reference to FIGS. 12 to 14. The magnetic rollers 422 are disposed in a vertical channel 429 between sides 425a, 425b that extends vertically between a lower and upper portion of the boom 410. The attachment assembly 470 comprises in this example fixtures in the form of a series of plastics eyelets 471 affixed to the material 413m of the containment body 413 of the containment boom 410. The eyelets 471 are disposed at vertically spaced apart positions along the channel 429 on each side of the channel 429. Each roller 422 has an axle 423 on which the roller 422 is mounted and about which the corresponding roller 422 rotates and which at each end is coupled to a side support 474. The side supports 474 are arranged at each side of the channel 429. The side supports 474 are positioned and extend vertically between adjacent eyelets 471. The side supports 474 comprise a ring or vertically extending bore 474b that aligns with the eye 471i of the adjacent eyelets 471. The attachment assembly 470 further has an elongate coupling member 478 that extends through the eyelets 471 and the ring or bore 474b of the side supports 474, thus connecting the magnet rollers 422 supported on the side supports 474 to the eyelets 471 and the body 413 of the containment boom. The elongate coupling member 478 in this example is in the form of a hoop that bridges across an upper end of the channel from one side of the channel to the other. Respective ends of the hoop are connected to each other or affixed to the body 413 of the containment boom at or near the lower end of the channel. The hoop 478 conveniently can provide for attaching a rope 450 to the containment boom, for example for assisting with retrieval and/or lifting out of the water after use.

In certain examples, the attaching structure by which the link means 420a is attached to the containment body 413 is a reconfigurable attaching structure through which one part is releasable or separable or configured to break apart from another part by an applied force in use. In certain such examples, the reconfigurable attaching structure for example in the form of attachment assembly 470 includes weak links which in FIG. 11 are the connections of the eyelets 471 to the material 413m of the containment boom. These connections are configured so that the eyelets give way and detach from the material 413m of containment body 413 upon being subjected to a force at or above a threshold value. More specifically, the connection gives way at or above a threshold value which is less than the force at which the material 413m of the boom in other parts of the containment boom breaks. The connection gives way at or above a threshold value that is less than the force required to detach the magnet rollers 422 from the side of the variable water line structure or less than the force required to sever one or more other parts of the attachment assembly, i.e. other parts needed for attaching the rollers to the containment boom body 413, such as the elongate coupling member 478, the side supports 474, or the axles 423.

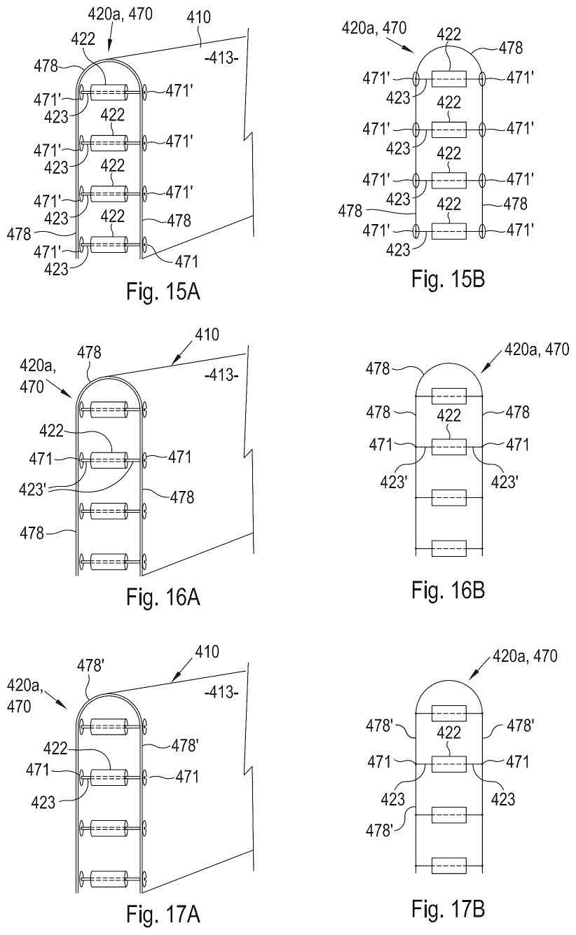

Variants of the attachment assembly 470 with other weak link configurations are depicted FIGS. 15A and 15B, FIGS. 16A and 16B, and FIGS. 17A and 17B.

In FIGS. 15A and 15B, weak links are the connections of the eyelets 471′ to the elongate coupling member 478. The apostrophe in the reference numeral 471′ is used to signify that the eyelet 471 is a weak link. The eyelet gives way and detaches from the coupling member 478 upon a force being applied exceeding a threshold value. The threshold is less than the force at which the material 413m breaks or at which the eyelet becomes detaches from the material 413m. Furthermore, the eyelet 471′ gives way to detach from the coupling member 478 at or above a threshold value that is less than the force required to detach the magnet rollers 422 from the side of the variable water line structure or less than the force required to sever one or more other parts of the attachment assembly, i.e. other parts needed for attaching the rollers to the containment boom main body 413, such as the side supports 474, or the axles 423.

In FIGS. 16A and 16B, weak links are the axles or bolts 423′ which connect the rollers 422 to the attachment assembly 470. The apostrophe in the reference numeral 423′ is used to signify that the axle or bolt 423 is a weak link. The axle or bolt 423′ for example of plastics material is configured to give way and release the roller magnet 422 upon being deformed by a force exceeding a threshold value, for example if the magnet roller becomes stuck. The threshold value can be less than the force at which the material 413m breaks or at which the eyelet 471 detaches from the material 413m. Furthermore, the axle or bolt 423′ gives way to allow release of the roller 422 at or above a threshold value that is less than the force required to detach the magnet rollers 422 from the side of the variable water line structure or less than the force required to sever or cause to give way one or more other parts of the attachment assembly, i.e. other parts used for attaching the rollers to the containment boom main body 413, such as the side supports 474, the coupling member 478, or the eyelets 471.

In FIGS. 17A and 17B, a weak link is provided in the form of the elongate coupling member 478′. The apostrophe in the reference numeral 478′ is used to signify that the coupling member 478 is a weak link. The coupling member 478′ is for example a tube of plastics material and configured to give way upon being subjected to a force (for example pulling and deforming the hoop where the rope 450 is connected) exceeding a threshold value. This may facilitate releasing or partially decoupling the main body 413 of the containment boom and eyelets from the magnet rollers 422 upon for example the rollers or the main body of the containment boom becoming stuck. The threshold value can be less than the force at which the material 413m breaks or at which the eyelet 471 detaches from the material 413m. Furthermore, the coupling member 478′ gives way to allow release of the roller 422 at or above a threshold value that is less than the force required to detach the magnet rollers 422 from the side of the variable water line structure or less than the force required to sever or cause to give way one or more other parts of the attachment assembly, i.e. other parts used for attaching the rollers to the containment boom main body 413, such as the side supports 474, the axle or bolts 423, or the eyelets 471.

By way of the attaching structure provided by the assembly being reconfigurable through one part being for example pulled away from another and released, obstructions or stuck conditions may be overcome. Through the weak links upon the leak means or containment boom main body 413 becoming stuck or obstructed, e.g. under quay structures or the like, a way of releasing the containment boom and retrieving the boom and/or its components can be facilitated. The boom configuration and/or containment body and/or link means and/or attaching structure can be altered in response to applied force to facilitate retrieval and/or to facilitate further use without obstruction or malfunction. For example, a weak link on the axle may allow an obstructed or stuck roller to be released to allow use of the containment boom to continue, e.g. rolling up/down on other rollers. As well as becoming stuck during use, the containment boom can become stuck when retrieving it, which can be an issue when operating in and around vessel and/or quay structures, especially when water levels rise and fall.

Many other configurations of weak links are possible in assemblies attaching the link means to the main body of the containment boom. Although the rollers in this example are mounted in the channel other alternatives for supporting the rollers in suitable position are possible. For example, a frame in which the rollers are mounted may be attached to a section or panel of material of the containment body. Such frame could be coupled to one or more fasteners, fixtures or connecting means on the material.

1. A containment boom for confining a spill in a region of water, the containment boom being configured to be supported on the water, the containment boom comprising:
a containment body; and
a link means for movably connecting and linking the containment body to a variable water level structure, permitting lift/lower movability of the containment body on the water in use with respect to the variable water level structure with relative changes in water level;
wherein the link means is attached to the containment body through a reconfigurable attaching structure in which one part is releasable or separable or configured to break apart from another part by an applied force;
wherein the link means comprises one or more magnet rollers configured to travel up/down on the variable water level structure with changes in water level, the one or more magnet rollers being configured to be detachable from the variable water level structure upon a pulling the link means away from the variable water level structure with a force exceeding a threshold value.

2. The containment boom as claimed in claim 1, wherein the one part is a part of the link means and the other part is any of: another part of the link means; a part of the containment body; a part of the reconfigurable attaching structure.

3. The containment boom as claimed in claim 1, wherein the reconfigurable attaching structure comprises one or more first eyelets, loops, or holes; one or more second eyelets, loops, or holes; and at least one coupling member which is arranged to couple the first eyelets, loops, or holes and the second eyelets, loops, or holes.

4. The containment boom as claimed in claim 1, wherein the reconfigurable attaching structure comprises an assembly for attaching the one or more magnet rollers to the containment body, the assembly comprising:
axles upon which the magnet rollers respectively are rotatably mounted, each axle supportably connected to a support member, fixtures of or affixed to a section of fabric or material of the containment body, the fixtures comprising first connector devices, second connector devices affixed to the support members, and a coupling member linking the first connector devices and the second connector devices to couple the support members to the fixtures.

5. The containment boom as claimed in claim 4, wherein the first connector devices are eyelets, loops, or holes and the second connector devices are eyelets, loops, or holes, and the coupling member is an elongate member arranged to pass through the eyelets, loops, or holes.

6. The containment boom as claimed in claim 1, wherein the reconfigurable attaching structure extending between the link means and the containment body comprises at least one severable link or weak link.

7. The containment boom as claimed in claim 1, wherein the containment body comprises a beam or float section and a skirt arranged to depend from the beam or float section into the water.

8. The containment boom as claimed in claim 7, wherein the containment body comprises a section of water permeable material configured to extend laterally underwater from a lower end of the skirt when linked to the variable water level structure in use.

9. (canceled)

10. A system comprising at least one variable water level structure and the containment boom as claimed in claim 1, wherein the containment body is supported floatingly on the water and is connected and linked to the variable water level structure through the link means, the containment body and the link means being movable by the water to lift/lower with respect to the variable water level structure with relative changes in water level.

11. A vessel having a containment boom extending between first link means at one end of the containment boom and second link means at a second end of the containment boom, the first and second link means movably connecting and linking the containment boom to a side of the vessel so as to rise/lower with respect to the side of the vessel with changes in water line, a region of water being confined by the containment boom between the containment boom and the vessel, the containment boom having a containment body and a section of permeable material extending laterally below the region of water, for collecting waste discharged from the vessel into the region of water, wherein either or both the first and second link means comprises one or more magnet rollers arranged to travel up/down on a variable water structure with changes in water level, the one or more magnet rollers being configured to be detachable from the variable water level structure upon a pulling the first and second link means away from the variable water level structure with a force exceeding a threshold value.

12. A method of using the containment boom as claimed in claim 1, the containment boom being deployed in the water and the containment body being connected and linked to a variable water line structure, the method comprising the step of subjecting the reconfigurable attaching structure, through which the link means is attached to the containment body of the containment boom, to such force as to release, separate or brake away at least one part from at least one other part to reconfigure the containment boom.

13. The method as claimed in claim 12, wherein the part is released, separated or broken away from the other part by an applied force exceeding a threshold value that is less than a tear or breaking limit of a material or fabric of the containment body to which the link means is attached.

14. The method as claimed in claim 12, wherein the one part is a stuck or obstructed part, and the method further comprises mechanically pulling part of the reconfigurable attaching structure, the containment body, or the reconfigurable attaching structure to apply the force to release, separate, or break away the one part from the other.

15. The method as claimed in claim 12, further comprising reconfiguring the containment boom to unstick, decouple or release one part of the containment boom from another to facilitate further operation or retrieval of the containment boom.

16. The method as claimed in claim 12, further comprising reconfiguring the containment boom to permit or facilitate retrieval or removal of any of the reconfigurable attaching structure, the containment body and link means from the region of water and/or variable water level structure.

17. The containment boom as claimed in claim 2, wherein the reconfigurable attaching structure comprises one or more first eyelets, loops, or holes; one or more second eyelets, loops, or holes; and at least one coupling member which is arranged to couple the first eyelets, loops, or holes and the second eyelets, loops, or holes.

18. The method as claimed in claim 13, wherein the one part is a stuck or obstructed part, and the method further comprising mechanically pulling part of the reconfigurable attaching structure, the containment body, or the reconfigurable attaching structure to apply the force to release, separate, or break away the one part from the other.

19. The method as claimed in claim 13, further comprising reconfiguring the containment boom to unstick, decouple or release one part of the containment boom from another to facilitate further operation or retrieval of the containment boom.

20. The method as claimed in claim 13, further comprising reconfiguring the containment boom to permit or facilitate retrieval or removal of any of the reconfigurable attaching structure, the containment body and link means from the region of water and/or variable water level structure.
